(19) United States
(12) Patent Application Publication
(10) Pub. No.: US 2004/0200676 A1
(43) Pub. Date: Oct. 14, 2004

(54) Electric sliding disc brake system

(76) Inventors: Huang-Tsang Chang, Dayton, OH (US); James Robert Waag, Miamisburg, OH (US)

Correspondence Address: Scott A. McBain, Delphi Technologies, Inc., Mail Code: 480-414-420, P.O. Box 5052, Troy, MI, 48007, US

(21) Appl. No.: 10/412,598

(22) Filed: Apr. 8, 2003

(51) Int. Cl. F16D 55/08

(52) U.S. Cl. 188/72.8; 188/162

(57) ABSTRACT

A slidable disc brake assembly for vehicles includes a rotatable hub, at least one friction disc rotatable but slidable along the hub, at least two friction pads on axially opposite sides of the disc with at least one being slidable on a brake caliper. The caliper is provided with an electric primary actuator which is operative to slide the brake disc and the friction pad or pads into frictional engagement with one another.

### BACKGROUND OF THE INVENTION

This invention relates generally to sliding disc-type brake systems for automotive vehicles and the like.

Sliding disc-type brake systems for automotive vehicles and the like are known to the art, such as the brake system disclosed in U.S. Pat. No. 6,371,250 which is commonly owned by the assignee of the present invention. Such systems include a rotatable hub adapted to mount a vehicle wheel and on which at least one and often two brake discs are supported for rotation with the hub and for slidable movement in the axial direction of the hub. Each friction disc has axially opposite friction surfaces which are engaged by associated friction pads. The friction pads are mounted on a brake caliper, and at least one or more of the friction pads is slidable along the caliper into and out of frictional engagement with the brake discs. The caliper is equipped with a hydraulic actuator for selectively moving the slidable friction pads and discs into frictional braking engagement with one another. The hydraulic actuator includes a piston received in a bore of the caliper and coupled to a source of hydraulic fluid which, when pressurized, pushes the piston axially toward the friction pads, sliding the pads and thus the discs into engagement.

One disadvantage with this type of sliding disc braking system is that it relies solely on hydraulics for the primary actuation of the braking mechanism. The hydraulics require the routing of a supply of hydraulic fluids to each caliper.

It is an object of the present invention to simplify the manufacture and operation of sliding disc-type brake systems, including eliminating the reliance on hydraulics as the primary means of actuating the brake system.

### SUMMARY OF THE INVENTION

A slidable disc brake assembly constructed according to the present invention includes a rotatable hub on which at least one friction disc is supported for rotation with the hub and for axial sliding movement relative to the hub. The assembly includes a brake caliper mounting at least two friction pads disposed on axially opposite sides of the friction disc. At least one of the friction pads is supported by the caliper for selective sliding movement into and out of frictional braking engagement with the friction disc. The caliper includes an electric actuator which is operative when actuated to slide the brake disc and the at least one friction pad into frictionable braking engagement with one another.

The invention has the advantage of eliminating hydraulics as the primary means of actuating the disc brake assembly. The electric actuator enables sliding disc-type brake assemblies to be used in brake-by-wire vehicle applications as the primary braking system for the vehicle wheels.

### BRIEF DESCRIPTION OF THE DRAWINGS

The present invention will now be described, by way of example, with reference to the accompanying drawings, in which:

FIG. 1 is a perspective view of an electrically actuated slidable disc brake assembly constructed according to an embodiment of the invention;

FIG. 2 is a cross-sectional view of the assembly of FIG. 1 shown in the unactuated condition;

FIG. 3 is a view like FIG. 3 but showing the assembly in a brake actuated condition;

FIG. 4 is a sectional view through the electric actuator showing details of the drive system; and

FIG. 5 is an enlarged fragmentary sectional view showing further features of the electric actuator.

### DESCRIPTION OF THE PREFERRED EMBODIMENT

An electrically actuated slidable disc brake assembly constructed according to a presently preferred embodiment of the invention is shown generally at 10 in the drawings and comprises a wheel hub 12 that is supported for rotation on a body 14 of a suspension link 16, forming part of a brake caliper member 18. The hub 12 is rotatable about an axis A and carries a plurality of studs 20 for mounting a vehicle wheel for rotation with the hub 12.

The rotatable hub 12 further supports at least one and preferably at least two friction discs 22 for rotation with the hub 12 about the axis A as well as for sliding movement relative to the hub 12 in the direction of the axis A. The friction discs 22 each have axially opposite friction surfaces 24a, 24b, and the discs 22 are spaced axially from one another on the hub 12. The discs 22 are disposed about an outer peripheral surface 26 of the hub 12 and are formed with a plurality of radially inwardly extending guide ribs or teeth 28 which are received in corresponding circumferentially spaced, axially extending guide slots or channels 30 formed in the outer surface 26 of the hub 12 for guiding the friction discs 22 for the axial sliding movement along the hub 12, while locking the discs 22 in the circumferential direction to cause the discs 22 to rotate with the hub 12 about the axis, while enabling the axial sliding movement of the discs 22 along the hub 12.

The brake caliper 18 includes a bridge portion 32 extending in the axial direction at a location spaced above the outer circumference of the friction discs 22. The bridge portion 32 supports a plurality of friction pads 34, at least one of which is slidable axially on the bridge 32 for movement into and out of frictional braking engagement with the friction discs 22, as will be explained in greater detail below. In the illustrated embodiment in which there are two friction discs 22 supported on the hub 12, the assembly 10 is provided with three of the friction pads generally designated at 34, and individually designated at 34a, 34b and 34c. 34a represents an inner-most friction pad disposed on the axially inner side of the innermost disc, 34b represents an intermediate friction pad disposed between the two discs, and 34c represents an axially outermost friction pad carried at the end of the bridge 32. The outermost friction pad 34c is preferably fixed stationarily to the bridge 32 and may form a permanent or removable part of the bridge structure 32. In the illustrated embodiment, the outer friction pad 32c is formed separately from the bridge portion 32, which in turn is formed separately from the body 14 of the brake caliper structure 18 and is joined thereto by a pair of mounting bolts 36 extending through a corresponding pair of aligned openings formed in the outermost friction pad 34c and bridge portion 32 which, in turn, are aligned with threaded bolt holes 38 in the caliper body 14 for rigidly mounting the bridge 32 and outermost pad 34 as a unified structure with the brake caliper body 14. While the bridge and outermost pad are shown as separate structures from the brake caliper body 14, the invention contemplates that one or both could be fabricated as one piece (i.e., the bridge 32 with the body 14 and/or the outer friction pad 34c with the bridge 32), or could otherwise be interconnected in a manner that does not rely entirely on the bolts 36 for connection to the caliper body 14.

The inner and central friction pads 34a, 34b are slidable axially on the bridge 32. The pads 34a, 34b as well as the outer friction pad 34c are “spot-type” friction pads which are discontinuous in the circumferential direction and sized relative to the friction disc 22 to engage only a portion of the friction surfaces 24a, 24b of the discs at any one time during braking. In other words, the contact area of the pads with the discs represents only a fraction of the friction surfaces 24a, 24b of the discs 22, such that the pads 34 do not extend continuously with the friction surfaces 24a, 24b of the discs 22, but extend only across a relatively small fraction of the area (e.g., 25% or less).

The inner and middle friction pads 34a, 34b are slidable on the bridge 32 in the axial direction A. The pads 34a, 34b are preferably suspended or hung on the bridge 32, and for this purpose the pads 34a, 34b preferably include a pair of laterally spaced hanger arms 40 which extend around and over top of opposing lateral side rails 42 of the bridge 32 in order to suspend the pads 34a, 34b from the bridge in interleaved relation to the friction discs 22, while enabling them to slide axially on the bridge 32. The bridge 32 preferably mounts a conventional anti-rattle leaf spring (not shown) which acts to press downwardly on the hanger arms 40 of the pads 34a, 34b to minimize lash and thus rattling of the pads 34a, 34b relative to the bridge 32. The hub 12 and/or discs 22 may be further fitted with known anti-rattle springs (not shown) which minimize lash in the lateral direction while enabling sliding movement of the discs 22 in the axial direction.

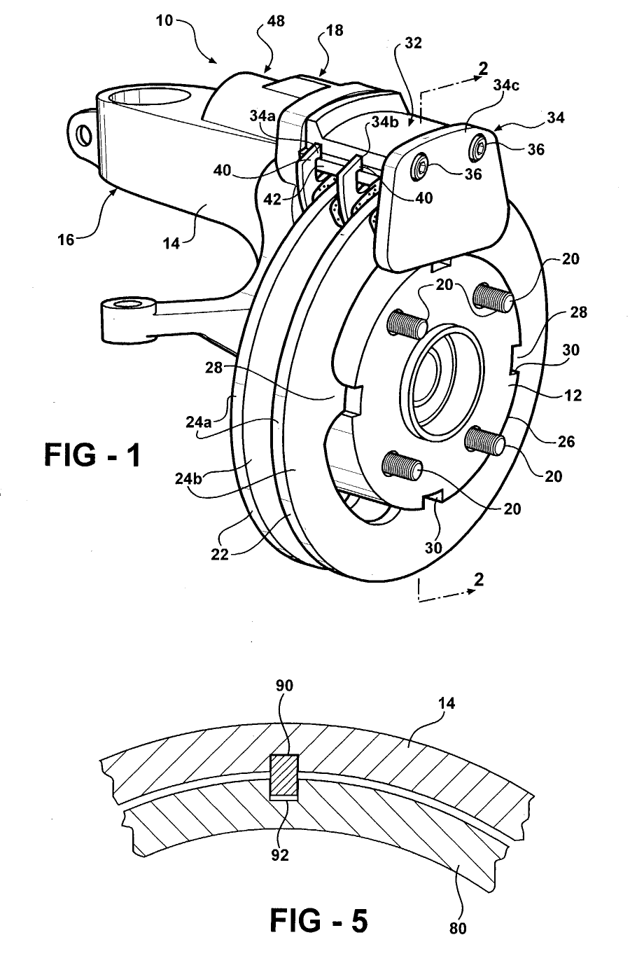

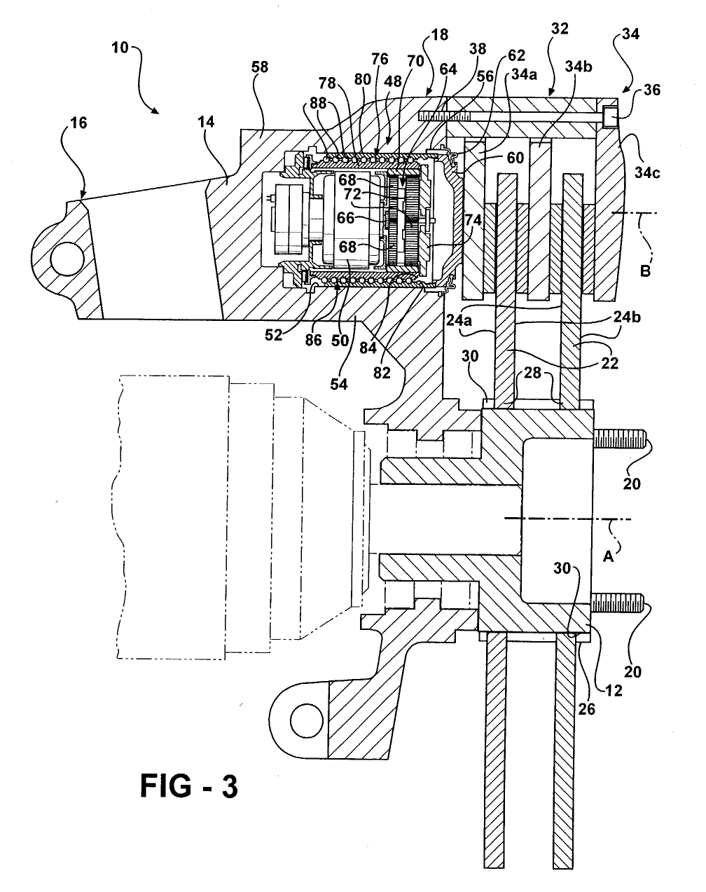

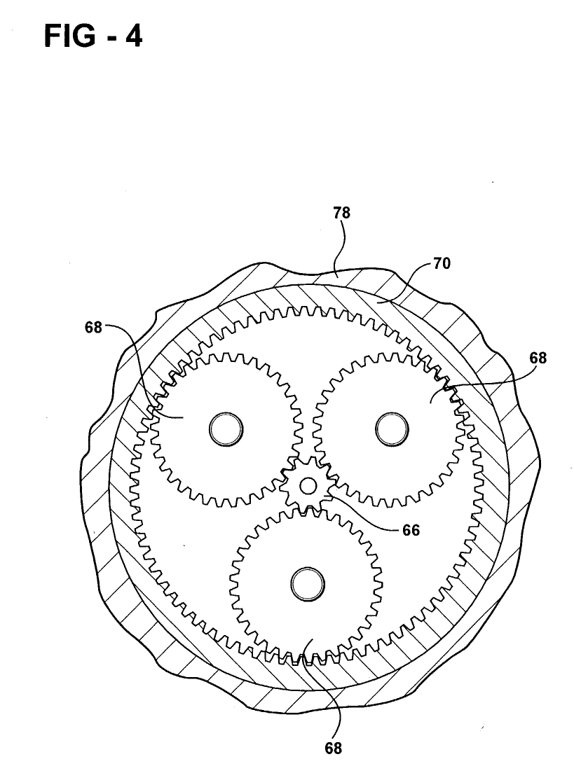

Referring to FIGS. 1-4, the brake caliper structure 18 supports or includes an electric primary actuator 48 which is operative when actuated to slide the brake discs 22 and at least one of the friction pads 34 into selective frictional braking engagement with one another. The actuator 48 comprises an electric motor 50 disposed within a bore 52 of a motor housing 54 which is preferably formed as part of the body 14 of the brake caliper 18 on which the friction pads 34 are supported. The motor housing 54 may be separately formed then joined to the brake caliper body 14, or, more preferably, formed at least in part as one piece with the body 14 of the same material, such as a one piece metal casting of iron or steel or the like. The motor housing 54 has an open end 56 facing the friction pads 34 in the axial direction of sliding of the friction pads 34 on the bridge 32. At opposite end 58 of the motor housing 54 is closed preferably by a sealed end cap 58 to protect the motor 50 from exposure to the environment outside of the housing 54. Of course, the end cap 58 could be formed as one piece with the housing structure 54 if desired.

The open end 56 of the housing 54 supports a piston 60 which is moveable along an axis B of the piston 60 toward and away from the friction pads 34 under operation of the motor 50 as will be described below. A bellows-type seal or boot 62 is connected to the open end 56 of the housing 54 about its outer perimeter, and to the piston 60 about its inner perimeter and is operative to seal the open end of the housing 54 against exposure to the outside environment during full travel of the piston 60 between its fully actuated and unactuated positions along the piston axis B as it moves relative to the housing 54. The bellows seal 60 expands and contracts with the movement of the piston 60 in the axial direction so as to maintain a sealed environment across the gap between the piston 60 and open end 56.

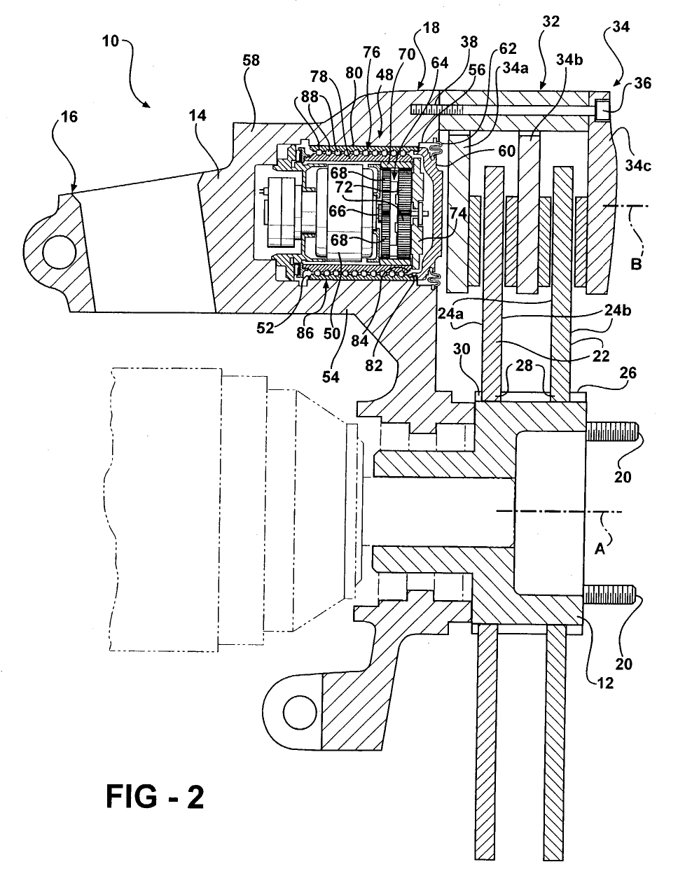

Referring particularly to FIGS. 2-4, the motor 50 drives a planetary gear system 64, which includes a central pinion gear 66 enmeshed with three primary planetary gears 68 which travel about an inner ring 70 and cause the inner ring 70 to rotate about the piston axis B. Another set of driven pinion gears 72 are mounted to an end plate 74 and are enmeshed with the rotatable inner ring 70 in such manner as to cause the end plate 70 to rotate at a reduced gear ratio. Those skilled in the art will appreciate that a particular gear ratio desired for a given application can be achieved through adjustment of the gearing, and for example the planetary gear system 64 of the present invention may provide an overall gear reduction between the pinion gear 66 and the end plate 74 of between 16:1 and 32:1, but a lesser or greater gear reduction is contemplated and incorporated herein by reference.

The end plate 74 is operatively coupled to a ball screw device 76 to translate the rotational movement of the end plate 74 into axial displacement of the piston 60. The ball screw device 76 includes a threaded screw portion 78 and a threaded nut portion 80 operatively engaging the threaded screw portion 78. The screw portion 78 is in the preferred form of a cylindrical sleeve disposed in the motor housing 54 about the motor 50 and fixed to the end plate 74 so as to rotate with the end plates 74 relative to the stationary motor 50 and housing 54. The screw portion 78 is spaced radially from both the motor 50 and motor housing 54. The nut portion 80 is disposed about the screw portion 78 and is fixed to the piston 60. The screw portion 78 is formed on its outer surface with a hellical groove 82 that complements a hellical groove 84 formed on an inner surface of the nut portion 80. The grooves 82, 84 cooperatively form a hellical pathway or ball race 86 in which a plurality of torque-transmitting rolling elements 88 in the preferred form of spherical balls are disposed. The nut portion 80 is supported for axial sliding movement relative to the housing 54 and screw portion 78, but against rotation relative thereto. As illustrated in FIG. 5, the nut portion 80 may be keyed to the motor housing 54 by means of a key 90 fixed to the housing 54 and extending into a longitudinal guide slot 92 of the nut portion 80 (or the reverse arrangement). Of course, those skilled in the art will appreciate and recognize that the key and slot arrangement is but one way of supporting the nut portion 80 for sliding but against rotational movement relative to the housing 54 and that many other alternative constructions could be employed that would achieve the same result of permitting sliding but not rotational movement of the nut portion 80 relative to the housing 54, including restraining the piston 60 which is coupled to the nut portion 80. Such alternatives are contemplated by the invention and incorporated herein by reference.

In operation, the brake pedal of the vehicle (not shown) is electrically connected to the electrical brake caliper 18. The application of force to the brake pedal initiates operation of the motor 50. The operation of the motor 50 actuates the planetary gear system 64 which rotates the screw portion 78 and initiates rolling of the balls 88 in the ball race 86, inducing a reactionary force causing displacement of the nut portion 80, and thus the piston 60 axially toward and into engagement with the nearest friction pad 34a, causing the pad 34a to slide axially along the bridge 32 of the caliper 18. The displacement of the friction pad 34a brings the pad 34a into engagement with the facing friction surface of the adjacent friction disc 22, and, in turn, slides the friction disc outwardly with the displacement of the piston 60, until such point as the slidable friction discs 22 and pads 34a, 34b and 34c stack against one another in frictional braking engagement so as to exert pressure on the discs 22 to slow the rotation of the associated wheels of the vehicle. The above electric brake caliper 18 is applicable to brake systems having at least one slidable friction pad in combination with at least one slidable friction disc or, as illustrated, with at least two or more slidable friction pads and two or more slidable friction discs. Upon releasing application of force on the brake pedal, the motor 50 is neutralized, and the piston 60 is free to float axially inwardly as necessary to accommodate the movement of the friction pads 34 out of frictional engagement with the friction discs 22. In this manner, any small force imparted by the friction discs 22 back on the friction pads 34 once the braking force is released will enable the pads to move out of engagement with the discs 22 to prevent frictional drag, while advantageously maintaining the friction pads 34 just out of engagement with the discs 22 to promote quick braking reaction in successive braking cycles.

Obviously, many modifications and variation of the present invention are possible in light of the above teachings. It is, therefore, to be understood that within the scope of the appended claims, the invention may be practiced otherwise than as specifically described. The invention is defined by the claims.

1. A slidable disc brake assembly, comprising:
a rotatable hub;
at least one friction disc supported on said hub for rotation with said hub and for axial sliding movement relative to said hub;
a brake caliper;
at least two friction pads disposed on axially opposite sides of said friction disc, at least one of said friction pads being supported by said brake caliper for selective sliding movement into and out of frictional braking engagement with said friction disc; and
said brake caliper including an electric primary actuator operative when actuated to slide said brake disc and said at least one friction pad into said frictional braking engagement with one another, said actuator including an electric motor driving a pinion gear coupled by a set of planetary gears to a screw portion of a ball screw to impart rotation to said screw portion, said screw portion coupled by a set of torque-transmitting balls to a nut portion of said ball screw for imparting translational movement to said nut, said nut being coupled to a piston which is displaced by said nut into operative engagement with an adjacent one of said friction pads to impart said frictional braking engagement of said friction pads and said friction discs.

2. The assembly of claim 1 including at least a second friction disc rotatable with and slidable on said hub.

3. The assembly of claim 2 where there are at least three of said friction pads, at least two of which are slidable on said caliper.

4. The assembly of claim 3 wherein said friction pads are suspended by said caliper for said sliding movement relative thereto.

5. The assembly of claim 1 wherein said electric actuator comprises the primary means of actuating said assembly.

6. A brake caliper assembly, comprising:
a brake caliper body having a bridge;
at least two friction pads disposed in axially spaced relation to one another, with at lest one of said friction pads being supported by said bridge for axial sliding movement along said bridge toward and away from the at lest one other of said friction pads; and an electric primary actuator supported by said caliper body and operative when actuated to slide said at least one friction pad axially toward said at least one other friction pad, said actuator including an electric motor driving a pinion gear coupled by a set of planetary gears to a screw portion of a ball screw to impart rotation to said screw portion, said screw portion coupled by a set of torque-transmitting balls to a nut portion of said ball screw for imparting translational movement to said nut, said nut being coupled to a piston which is displaced by said nut into operative engagement with an adjacent one of said friction pads to impart said frictional braking engagement of said friction pads and said friction discs.

7. The assembly of claim 6 wherein there are at least three of said friction pads, at least two of which are slidable on said caliper bridge.
